(19) United States
(12) Patent Application Publication
(10) Pub. No.: US 2026/0140854 A1
(43) Pub. Date: May 21, 2026

(54) FUZZING APPARATUS AND FUZZING METHOD

(71) Applicant: Mitsubishi Electric Corporation, Chiyoda-ku, Tokyo (JP)

(72) Inventor: Takuhiro KUMAGAI, Tokyo (JP)

(73) Assignee: Mitsubishi Electric Corporation, Chiyoda-ku, Tokyo (JP)

(21) Appl. No.: 19/118,964

(22) PCT Filed: Oct. 12, 2023
(86) PCT No.: PCT/JP2023/037011

§ 371 Date: Apr. 7, 2025

(30) Foreign Application Priority Data
Jan. 10, 2023 (WO) PCT/JP2023/000289

(51) Int. Cl. G06F 11/3668; G06F 11/30

(52) U.S. Cl. CPC G06F 11/3688; G06F 11/302

(57) ABSTRACT

An object is to provide a technique capable of increasing efficiency of executing a fuzzing test. A restart controller restarts a test target apparatus when a monitoring part monitors that the test target apparatus is crushed on fuzzing using a plurality of fuzzes, the fuzzing execution part executes the fuzzing using one or more fuzzes after the test target apparatus is restarted, and one or more fuzzes including a fuzz crushing the test target apparatus is specified based on a monitoring result of the monitoring part on the fuzzing using one or more fuzzes.

### TECHNICAL FIELD

The present disclosure relates to a fuzzing apparatus and a fuzzing method.

### BACKGROUND ART

An inspection method referred to as fuzzing is known to find unknown vulnerability of an apparatus. The fussing is a test for making an apparatus execute a fuzz as data which is likely to cause a problem of the apparatus and confirming vulnerability of an apparatus based on presence or absence of occurrence of abnormality such as crush of the apparatus. In this fuzzing, because of a characteristic thereof, there is a case where the test cannot be normally performed to the last when abnormality occurs in the apparatus during the test.

Thus, proposed in Patent Document 1, for example, is a technique of monitoring a state of an apparatus by a fuzzing agent and automatically outputting information of the apparatus and restarting the apparatus when abnormality occurs in the apparatus. According to such a technique, time and effort of monitoring the apparatus by a human is reduced, and a sequential operation of the fuzzing can be automatically performed.

### PRIOR ART DOCUMENTS

### Patent Document(s)

Patent Document 1: U.S. Pat. No. 11,175,992 specification

### SUMMARY

### Problem to Be Solved by the Invention

However, the conventional technique does not have a configuration of automatically specifying a fuzz causing crush of a test target apparatus. Thus, when the test target apparatus is crushed, a performer of the fuzzing test needs to perform an operation of manually specifying a fuzz causing the crush, and there is room for improvement in efficiency of executing the fuzzing test.

The present disclosure is therefore has been made to solve problems as described above, and it is an object of the present disclosure to provide a technique capable of increasing efficiency of executing a fuzzing test.

### Means to Solve the Problem

A fuzzing test according to the present disclosure includes: a fuzzing execution part executing fuzzing of a test target apparatus; a monitoring part monitoring whether or not the test target apparatus is crushed; a restart controller restarting the test target apparatus; and a fuzzing controller controlling the fuzzing execution part and the restart controller, wherein the fuzzing controller makes the fuzzing execution part execute the fuzzing using a plurality of fuzzes, makes the restart controller restart the test target apparatus when the monitoring part monitors that the test target apparatus is crushed, makes the fuzzing execution part execute the fuzzing using one or more fuzzes less than the plurality of fuzzes in number in the plurality of fuzzes after the test target apparatus is restarted, and specifies the one or more fuzzes including a fuzz crushing the test target apparatus based on a monitoring result of the monitoring part on the fuzzing using the one or more fuzzes.

### Effects of the Invention

According to the present disclosure, specified is one or more fuzzes including a fuzz crushing the test target apparatus based on the monitoring result of the monitoring part on the fuzzing using one or more fuzzes. Thus, efficiency of executing the fuzzing test can be increased.

These and other objects, features, aspects and advantages of the present disclosure will become more apparent from the following detailed description of the specification when taken in conjunction with the accompanying drawings.

### BRIEF DESCRIPTION OF DRAWINGS

FIG. 1 is a block diagram illustrating a configuration of a fuzzing apparatus according to an embodiment 1.

FIG. 2 is a flow chart illustrating processing of the fuzzing apparatus according to the embodiment 1.

FIG. 3 is a flow chart illustrating processing of the fuzzing apparatus according to the embodiment 1.

FIG. 4 is a flow chart illustrating processing of a fuzzing apparatus according to an embodiment 2.

FIG. 5 is a flow chart illustrating processing of the fuzzing apparatus according to the embodiment 2.

FIG. 6 is a block diagram illustrating a configuration of a monitoring part according to an embodiment 3.

FIG. 7 is a block diagram illustrating a hardware configuration of a fuzzing apparatus according to another modification example.

FIG. 8 is a block diagram illustrating a hardware configuration of a fuzzing apparatus according to another modification example.

### DESCRIPTION OF EMBODIMENT(S)

### Embodiment 1

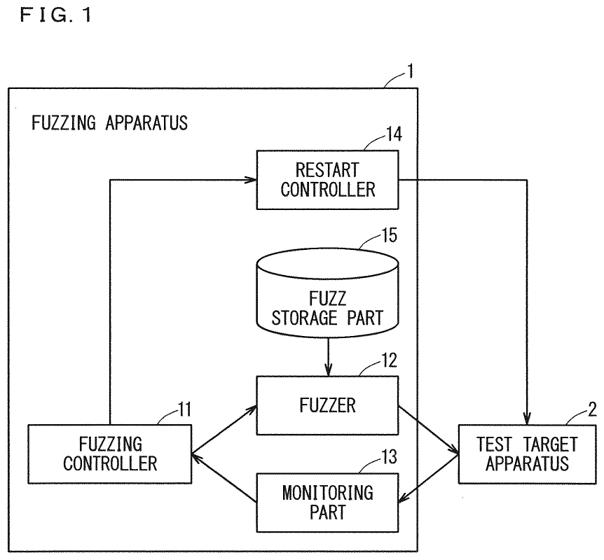

A fuzzing apparatus 1 according the present embodiment 1 is an automatic fuzzing apparatus capable of automatically performing fuzzing continuously. FIG. 1 is a block diagram illustrating a configuration of the fuzzing apparatus 1 according to the present embodiment 1. The fuzzing apparatus 1 in FIG. 1 includes a fuzzing controller 11, a fuzzer 12 as a fuzzing execution part, a monitoring part 13, a restart controller 14, and a fuzz storage part 15.

The fuzzing controller 11 is connected to the fuzzer 12, the monitoring part 13, and the restart controller 14 to control the fuzzer 12 and the restart controller 14. Specific control of the fuzzing controller 11 is described hereinafter.

The fuzz storage part 15 stores a plurality of fuzzes which have been previously defined. The fuzz is data different from normal data assumed in a program of a test target apparatus 2, and is a data which is likely to cause a problem of the test target apparatus 2, for example. An identification number may be allocated to each of the plurality of fuzzes.

Upon receiving instruction of starting the test from the fuzzing controller 11, the fuzzer 12 takes out the plurality of fuzzes from the fuzz storage part 15, and transmits the plurality of fuzzes to the test target apparatus 2. Accordingly, the fuzzer 12 executes fuzzing of the test target apparatus 2 using the plurality of fuzzes. In the present embodiment 1, the state where the fuzz is used for fuzzing is substantially the same as the state where the fuzz is transmitted to the test target apparatus 2, and the plurality of fuzzes are sequentially used one by one in accordance with a predetermined order of the plurality of fuzzes.

The monitoring part 13 regularly performs communication with the test target apparatus 2 to monitor a state of the test target apparatus 2,such as whether or not the test target apparatus 2 is crushed. For example, when there is no response from the test target apparatus 2 even though a preset time passes after fuzzing of the test target apparatus 2 is executed, the monitoring part 13 notifies the fuzzing controller 11 of a monitoring result that the test target apparatus 2 is crushed. In the present embodiment 1, monitoring of the monitoring part 13 is relatively slow, and when the fuzzing controller 11 receives the monitoring result of crush, not only a fuzz crushing the test target apparatus 2 but also subsequent fuzzes are executed.

Upon receiving instruction of restart from the fuzzing controller 11, the restart controller 14 restarts the test target apparatus 2.

Described next is the fuzzing controller 11 controlling the fuzzer 12 and the restart controller 14. The fuzzing controller 11 makes the fuzzer 12 execute fuzzing using the plurality of fuzzes. The monitoring part 13 regularly monitors whether or not the test target apparatus 2 is crushed while such fuzzing is executed.

When the monitoring part 13 monitors that the test target apparatus 2 is crushed, the fuzzing controller 11 makes the restart controller 14 restart the test target apparatus 2. In the present embodiment 1, when the monitoring part 13 monitors that the test target apparatus 2 is crushed, the fuzzing controller 11 controls the fuzzer 12 so that the fuzzer 12 stops executing fuzzing of the test target apparatus 2 in addition to the control of restart of the test target apparatus 2.

After the test target apparatus 2 is restarted, the fuzzing controller 11 makes the fuzzer 12 execute fuzzing using one or more fuzzes less than the plurality of fuzzes in number in the plurality of fuzzes which have been executed. In the description hereinafter, in order to distinguish the plurality of fuzzes and one or more fuzzes less than the plurality of fuzzes, the latter fuzz may be referred to as “one or more re-executed fuzzes” in some cases.

In the present embodiment 1, one or more re-executed fuzzes used after the test target apparatus 2 is restarted includes a first fuzz to a second fuzz in an order of the plurality of fuzzes sequentially used for fuzzing.

The first fuzz is a fuzz used for fuzzing when the monitoring part 13 monitors that the test target apparatus 2 is crushed. For example, the first fuzz is a fuzz used for fuzzing at a point of time when the monitoring part 13 monitors crush of the test target apparatus 2 or a fuzz used for fuzzing at a point of time closest to the above point of time.

The second fuzz is a fuzz used for fuzzing at a predetermined time before the point of time when the first fuzz is used for fuzzing. Applied to the predetermined time is a time long enough to include the fuzz crushing the test target apparatus 2 from the first fuzz to the second fuzz. In the description hereinafter, the fuzz crushing the test target apparatus 2 is also referred to as “cause fuzz” in in some cases.

The fuzzing controller 11 specifies one or more re-executed fuzzes including the cause fuzz based on the monitoring result of the monitoring part 13 on fuzzing using one or more re-executed fuzzes.

In the present embodiment 1, the fuzzing controller 11 sets a time interval of using one or more re-executed fuzzes to be longer than a time interval of using fuzzing using the plurality of fuzzes. That is to say, with regard to a transmission rate of the fuzz transmitted from the fuzzer 12 to the test target apparatus 2, the fuzzing controller 11 sets a transmission rate of one or more re-executed fuzzes to be lower than that of the plurality of fuzzes which have been already executed. Since the time from transmission of a certain fuzz to transmission of a next fuzz can be set to sufficiently long, the cause fuzz can be specified even when the monitoring of the monitoring part 13 is relatively slow.

The fuzzing controller 11 may record or output the cause fuzz when specifying the cause fuzz. The fuzzing controller 11 increases the transmission rate of the fuzz to an original transmission rate when specifying the cause fuzz, and makes the fuzzer 12 execute fuzzing using the fuzz next to the first fuzz described above. According to such a configuration, the transmission rate is reduced only when one or more re-executed fuzzes including the cause fuzz is specified; thus, efficiency of the fuzzing test can be increased.

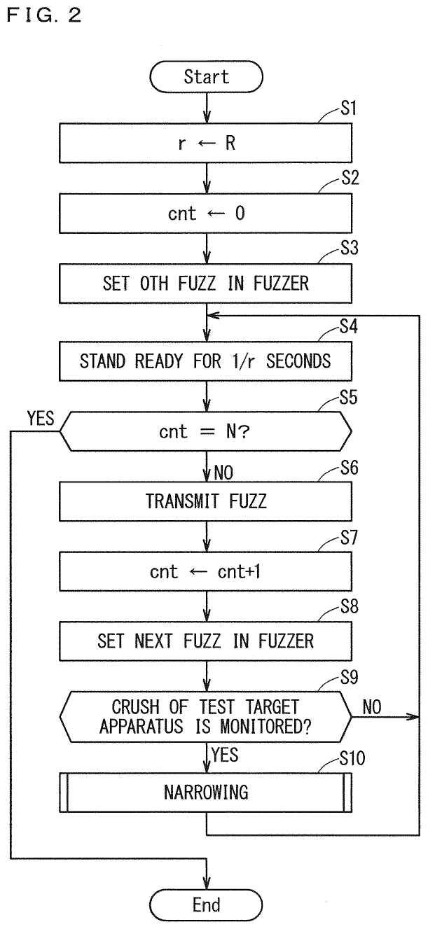

FIG. 2 is a flow chart illustrating processing of the fuzzing apparatus 1 according to the present embodiment 1. In the description hereinafter, it is assumed that a time interval in which the monitoring part 13 can specify one fuzz crushing the test target apparatus 2 is 1 [s], and the fuzz storage part 15 stores N (N is the number of fuzzes) fuzzes.

In Step S1, the fuzzing controller 11 sets a transmission rate r [/s] of the fuzzer 12 to a transmission rate R (wherein R>1) [/s] designated by a user of the fuzzing apparatus 1.

In Step S2, the fuzzing controller 11 sets the number of fuzzes cnt transmitted from the fuzzer 12 to 0.

In Step S3, the fuzzing controller 11 sets a 0^{th} fuzz in the fuzzer 12.

In Step S4, the fuzzing controller 11 stands ready for 1/r [s], that is to say, a period of time in which the fuzzer 12 should transmit one fuzz.

In Step S5, the fuzzing controller 11 determines whether or not the number of fuzzes cnt transmitted from the fuzzer 12 coincides with the total number N of fuzzes which should be transmitted. When it is determined that they coincide with each other, the process in FIG. 2 is finished, and when it is determined that they do not coincide with each other, the process proceeds to Step S6.

In Step S6, the fuzzing controller 11 makes the fuzzer 12 transmit the fuzz set in the fuzzer 12 to the test target apparatus 2.

In Step S7, the fuzzing controller 11 increments the number cnt transmitted from the fuzzer 12.

In Step S8, the fuzzing controller 11 sets a fuzz next to the transmitted fuzz, that is to say, a cnt^{th} fuzz changed in Step S7 in the fuzzer 12.

In Step S9, the fuzzing controller 11 determines whether or not the fuzzing controller 11 receives notification from the monitoring part 13, that is to say, whether or not the monitoring part 13 monitors crush of the test target apparatus 2. When it is determined that the crush is monitored, the process proceeds to Step S10, and when it is not determined that the crush is monitored, the process returns to Step S4.

In Step S10, the fuzzing controller 11 performs processing of narrowing the cause fuzz. Subsequently, the process returns to Step S4.

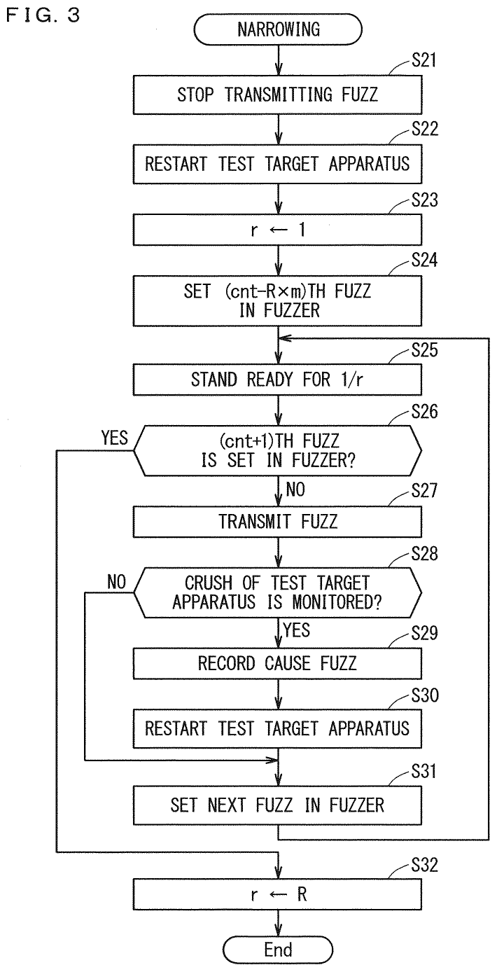

FIG. 3 is a flow chart illustrating the processing of narrowing the cause fuzz performed in Step S10 in FIG. 2.

In Step S21, the fuzzing controller 11 controls the fuzzer 12 so that the fuzzer 12 stops transmitting the fuzz.

In Step S22, the fuzzing controller 11 makes the restart controller 14 restart the test target apparatus 2.

In Step S23, the fuzzing controller 11 sets the transmission rate r [/s] of the fuzzer 12 to 1. That is to say, the fuzzing controller 11 reduces the transmission rate of the fuzzer 12 to have the time interval in which the monitoring part 13 can specify one fuzz crushing the test target apparatus 2.

In Step S24, the fuzzing controller 11 sets a (cnt−R×m)^{th} fuzz in the fuzzer 12. The cnt^{th} fuzz corresponds to the first fuzz, the (cnt−R×m)^{th} fuzz corresponds to the second fuzz, and m corresponds to a predetermined time for regulating the second fuzz.

In Step S25, the fuzzing controller 11 stands ready for 1/r [s], that is to say, a period of time in which the fuzzer 12 should transmit one fuzz.

In Step S26, the fuzzing controller 11 determines whether or not a (cnt+1)^{th} fuzz, that is to say, a fuzz next to the first fuzz is set in the fuzzer 12. When it is determined that the (cnt+1)^{th} fuzz is set, the process proceeds to Step S32, and when it is not determined that the (cnt+1)^{th} fuzz is set, the process proceeds to Step S27.

In Step S27, the fuzzing controller 11 makes the fuzzer 12 transmit the fuzz set in the fuzzer 12 to the test target apparatus 2.

In Step S28, the fuzzing controller 11 determines whether or not the monitoring part 13 monitors crush of the test target apparatus 2. When it is determined that the crush is monitored, the process proceeds to Step S29, and when it is not determined that the crush is monitored, the process proceeds to Step S31.

In Step S23, the transmission rate of the fuzzer 12 is changed to an approximately time interval in which the monitoring part 13 can specify one fuzz crushing the test target apparatus 2. Thus, in Step S29, the fuzzing controller 11 specifies the fuzz transmitted last as the cause fuzz, and records the cause fuzz.

In Step S30, the fuzzing controller 11 makes the restart controller 14 restart the test target apparatus 2.

In Step S31, the fuzzing controller 11 sets a fuzz next to the transmitted fuzz in the fuzzer 12. Subsequently, the process returns to Step S25.

When the process proceeds from Step S26 to Step S32, the fuzzing controller 11 returns the transmission rate r [/s] of the fuzzer 12 to R [/s]. Subsequently, the process in FIG. 3 is finished. Since cnt itself is not changed in the process in FIG. 3, fuzzing is performed using a fuzz next to the cnt^{th} fuzz after Step S10 in FIG. 2.

### Conclusion of Embodiment 1

According to the fuzzing apparatus 1 in the present embodiment 1 described above, the test target apparatus 2 is restarted when the monitoring part 13 monitors the crush of the test target apparatus 2, and subsequently, fuzzing is executed using one or more re-executed fuzzes to specify one or more re-executed fuzzes including the cause fuzz based on the monitoring result of the monitoring part 13. According to such a configuration, one or more re-executed fuzzes less than the plurality of fuzzes in number and including the cause fuzz can be specified. Since the operation of manually specifying the cause fuzz performed by the user of the fuzzing apparatus 1 can be reduced, efficiency of executing the fuzzing test can be increased. The condition that the number of one or more re-executed fuzzes is less than that of the plurality of fuzzes needs not be always established; however, it is sufficient that there is a possibility that this condition is established.

### Embodiment 2

A block diagram illustrating a configuration of the fuzzing apparatus 1 according to the present embodiment 2 is similar to that in FIG. 1. The same or similar reference numerals as those described above will be assigned to the same or similar constituent elements according to the present embodiment 2, and the different constituent elements are mainly described hereinafter.

The fuzzing controller 11 according to the present embodiment 2 makes the fuzzer 12 transmit all the fuzzes stored in the fuzz storage part 15 to the test target apparatus 2. Then, in the manner similar to the embodiment 1, the fuzzing controller 11 restarts the test target apparatus 2 when the monitoring part 13 monitors the crush of the test target apparatus 2, and subsequently, fuzzing is executed using one or more re-executed fuzzes to specify one or more re-executed fuzzes including the cause fuzz based on the monitoring result of the monitoring part 13.

In the present embodiment 2, one or more re-executed fuzzes selectively include the primary first fuzz to the second fuzz corresponding to half of the plurality of fuzzes and a third fuzz next to the second fuzz to a final fourth fuzz in an order in which the plurality of fuzzes are sequentially used for fuzzing. When the number of the plurality of fuzzes is an even number, the second fuzz is a fuzz half of the plurality of fuzzes, and when the number of the plurality of fuzzes is an odd number, the second fuzz is a fuzz immediately before or after half of the plurality of fuzzes. The fuzzing controller 11 recursively performs the sequential processes described above, thereby specifying one or more re-executed fuzzes including the cause fuzz by a method similar to a binary search.

In the present embodiment 2, when it is monitored that the test target apparatus 2 is crushed, the fuzzing controller 11 does not make the fuzzer 12 stop executing fuzzing of the test target apparatus 2.

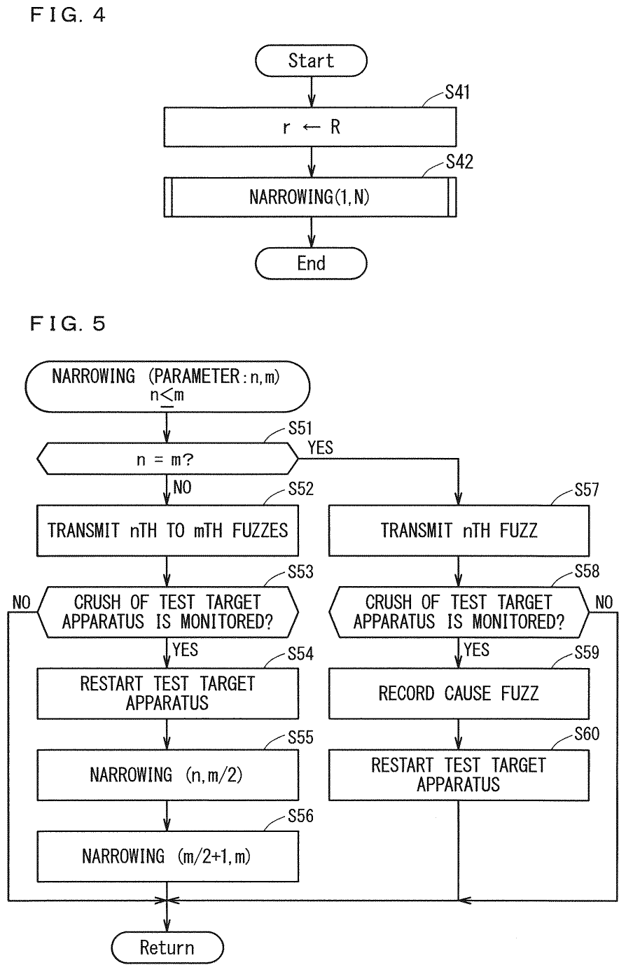

FIG. 4 is a flow chart illustrating processing of the fuzzing apparatus 1 according to the present embodiment 2. In the description hereinafter, it is assumed that a time interval in which the monitoring part 13 can specify one fuzz crushing the test target apparatus 2 is 1 [s], and the fuzz storage part 15 stores N fuzzes.

In Step S41, the fuzzing controller 11 sets a transmission rate r [/s] of the fuzzer 12 to the transmission rate R (wherein R>1) [/s] designated by the user of the fuzzing apparatus 1.

In Step S42, the fuzzing controller 11 calls up a narrowing flow for narrowing the cause fuzz, wherein 1 and N are parameters. Subsequently, the process in FIG. 4 is finished.

FIG. 5 is a flow chart illustrating the processing of narrowing the cause fuzz performed in Step S42 in FIG. 4. In the description hereinafter, it is assumed that a call name of the process in FIG. 5 is “narrowing”, and the process in FIG. 5 receives “n” expressing a primary of an order of fuzzes to be narrowed and “m” expressing a final thereof (wherein, n≤m is satisfied) as parameters.

In Step S51, the fuzzing controller 11 determines whether or not n and m are equal to each other. When it is determined that they are equal to each other, the process proceeds to Step S57, and when it is not determined that they are equal to each other, the process proceeds to Step S52.

In Step S52, the fuzzing controller 11 makes the fuzzer 12 transmit n^{th} to m^{th} fuzzes to the test target apparatus 2 at the transmission rate r [/s].

In Step S53, the fuzzing controller 11 determines whether or not the monitoring part 13 monitors crush of the test target apparatus 2 caused by fuzzing using the n^{th} to m^{th} fuzzes. When it is determined that the crush is monitored, the process proceeds to Step S54, and when it is not determined that the crush is monitored, the process in FIG. 5 is finished and returns to the processing of calling up the narrowing flow.

In Step S54, the fuzzing controller 11 makes the restart controller 14 restart the test target apparatus 2.

In Step S55, the fuzzing controller 11 calls up the narrowing flow, wherein n and m/2 are parameters. Accordingly, the narrowing flow is recursively performed, wherein the n^{th} fuzz corresponding to the first fuzz and m/2^{th} fuzz corresponding to the second fuzz are parameters.

In Step S56, the fuzzing controller 11 calls up the narrowing flow, wherein (m/2+1) and m are parameters. Accordingly, the narrowing flow is recursively performed, wherein the (m/2+1)^{th} fuzz corresponding to the third fuzz and m^{th} fuzz corresponding to the fourth fuzz are parameters. Subsequently, the process in FIG. 5 is finished, and returns to the processing of calling up the narrowing flow.

When the process proceeds from Step S51 to Step S57, the fuzzing controller 11 makes the fuzzer 12 transmit the n^{th} fuzz to the test target apparatus 2 at the transmission rate r [/s].

In Step S58, the fuzzing controller 11 determines whether or not the monitoring part 13 monitors crush of the test target apparatus 2 caused by fuzzing using the n^{th} fuzz. When it is determined that the crush is monitored, the process proceeds to Step S59, and when it is not determined that the crush is monitored, the process in FIG. 5 is finished and returns to the process of calling up the narrowing flow.

In Step S59, the fuzzing controller 11 specifies the n^{th} fuzz as the cause fuzz, and records the cause fuzz.

In Step S60, the fuzzing controller 11 makes the restart controller 14 restart the test target apparatus 2. Subsequently, the process in FIG. 5 is finished, and returns to the processing of calling up the narrowing flow.

### Conclusion of Embodiment 2

According to the fuzzing apparatus 1 in the present embodiment 2 described above, the test target apparatus 2 is restarted when the monitoring part 13 monitors the crush of the test target apparatus 2, and subsequently, fuzzing is executed using one or more re-executed fuzzes to specify one or more re-executed fuzzes including the cause fuzz based on the monitoring result of the monitoring part 13. According to such a configuration, the operation of manually specifying the cause fuzz performed by the user of the fuzzing apparatus 1 can be reduced in the manner similar to the embodiment 1; thus, efficiency of executing the fuzzing test can be increased.

In the present embodiment 2, one or more re-executed fuzzes including the cause fuzz is specified by the method similar to the binary search; thus, the number of monitoring the monitoring part 13 can be reduced.

### Embodiment 3

A block diagram illustrating a configuration of the fuzzing apparatus 1 according to the present embodiment 3 is substantially similar to that in FIG. 1. The same or similar reference numerals as those described above will be assigned to the same or similar constituent elements according to the present embodiment 3, and the different constituent elements are mainly described hereinafter.

In the present embodiment 3, the monitoring part 13 monitors whether or not a response from the test target apparatus 2 is normal. The fuzzing controller 11 makes the fuzzer 12 transmit all the fuzzes stored in the fuzz storage part 15 to the test target apparatus 2. Then, when the monitoring part 13 monitors that the response from the test target apparatus 2 is abnormal, the fuzzing controller 11 restarts the test target apparatus 2. Then, the fuzzing controller 11 makes the fuzzer 12 execute fuzzing using one or more re-executed fuzzes, and specifies one or more re-executed fuzzes including the cause fuzz causing abnormality of response from the test target apparatus 2 based on the monitoring result of the monitoring part 13.

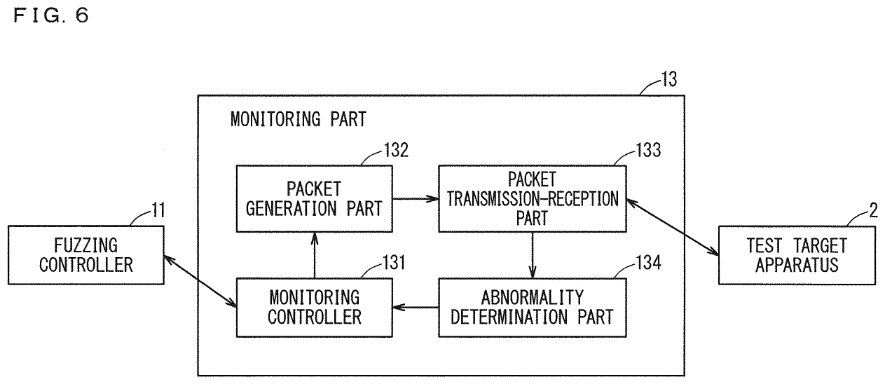

FIG. 6 is a block diagram illustrating a configuration of the monitoring part 13 of the fuzzing apparatus 1 according to the present embodiment 3. The monitoring part 13 in FIG. 6 includes a monitoring controller 131, a packet generation part 132, a packet transmission-reception part 133, and an abnormality determination part 134.

The monitoring controller 131 controls monitoring. The packet generation part 132 generates an optional packet upon receiving control from the monitoring controller 131. The packet transmission-reception part 133 transmits the packet generated in the packet generation part 132 to the test target apparatus 2, and receives the packet from the test target apparatus 2. The abnormality determination part 134 determines whether or not the response from the test target apparatus 2 is abnormal based on information of the packet received in the packet transmission-reception part 133. The monitoring part 13 having such a configuration can perform a first monitoring to a third monitoring described hereinafter.

### First Monitoring

Monitoring of the monitoring part 13 includes a process of sequentially transmitting the packet to the test target apparatus 2 at an optional interval and monitoring whether the response comes from the test target apparatus 2 in a response time as a predetermined time. The monitoring part 13 determines that the response is normal when the response comes in the time, and determines that the response is abnormal when the response does not come in the time. This configuration is described in detail hereinafter.

The abnormality determination part 134 defines a threshold value of the response time for the transmitted packet. The monitoring controller 131 notifies the packet generation part 132 of generation of the packet, and upon being notified, the packet generation part 132 generates the packet. The packet generation part 132 sequentially outputs the generated packet to the packet transmission-reception part 133, and the packet transmission-reception part 133 sequentially transmits the packet to the test target apparatus 2. The packet transmission-reception part 133 notifies the abnormality determination part 134 of a transmission time of the packet together with transmission of the packet to the test target apparatus 2. Subsequently, upon receiving the response from the test target apparatus 2, the packet transmission-reception part 133 notifies the abnormality determination part 134 of a receiving time of the packet. The abnormality determination part 134 calculates the response time of the test target apparatus 2 from the transmission time and the receiving time of the packet, and compares the response time with a predefined threshold value. Then, when the response time is smaller than the threshold value, the abnormality determination part 134 determines that the response from the test target apparatus 2 is normal, and when the response time is larger than the threshold value, the abnormality determination part 134 determines that the response from the test target apparatus 2 is abnormal.

### Second Monitoring

Monitoring of the monitoring part 13 includes monitoring whether or not response indicating a correct content comes from the test target apparatus 2 for the packet transmitted from the packet transmission-reception part 133. The monitoring part 13 determines that the response is normal in a period during which response indicating a correct content comes by the communication of the packet transmission-reception part 133, and determines that the response is abnormal in a period during which response deviating from a correct content comes. This configuration is described in detail hereinafter.

The abnormality determination part 134 previously defines a combination of correct responses for the content of the transmitted packet, and holds the combination as a table. The monitoring controller 131 notifies the packet generation part 132 of generation of the packet, and upon being notified, the packet generation part 132 generates the packet. The packet generation part 132 sequentially outputs the generated packet to the packet transmission-reception part 133, and the packet transmission-reception part 133 sequentially transmits the packet to the test target apparatus 2. Subsequently, upon receiving the response from the test target apparatus 2, that is to say, the packet, the packet transmission-reception part 133 outputs the received packet to the abnormality determination part 134. The abnormality determination part 134 refers to the table which has been previously defined to confirm whether the content of the transmitted packet corresponds to the content of the received packet. Then, when they correspond to each other, the abnormality determination part 134 determines that the response from the test target apparatus 2 is normal, and when they do not correspond to each other, the abnormality determination part 134 determines that the response from the test target apparatus 2 is abnormal.

### Third Monitoring

Monitoring of the monitoring part 13 includes monitoring whether or not response indicating a state transition of correct communication comes from the test target apparatus 2. The monitoring part 13 determines that the response is normal in a period during which response indicating a correct state transition comes from the test target apparatus 2 by the communication, and determines that the response is abnormal in a period during which response indicating an inappropriate state transition comes from the test target apparatus 2. This configuration is described in detail hereinafter.

The abnormality determination part 134 previously defines an order of packets transmitted to the test target apparatus 2 and an order of correct responses for the transmitted packets and holds the orders as tables. The monitoring controller 131 notifies the packet generation part 132 of generation of the packet corresponding to a current state in accordance with the table. The packet generation part 132 generates the packet corresponding to the current state. The packet generation part 132 sequentially outputs the generated packet to the packet transmission-reception part 133, and the packet transmission-reception part 133 sequentially transmits the packet to the test target apparatus 2. Subsequently, upon receiving the response from the test target apparatus 2, that is to say, the packet, the packet transmission-reception part 133 outputs the received packet to the abnormality determination part 134. The abnormality determination part 134 refers to the table which has been previously defined to confirm whether the response comes with a correct content in a correct order for the order of the transmitted packet. Then, when the response come with the correct content in the correct order, the abnormality determination part 134 determines that the response from the test target apparatus 2 is normal, and when the response comes with the incorrect content in the incorrect order, the abnormality determination part 134 determines that the response from the test target apparatus 2 is abnormal.

### Conclusion of Embodiment 3

According to the fuzzing apparatus 1 in the present embodiment 3 described above, the test target apparatus 2 is restarted when the monitoring part 13 monitors that the response from the test target apparatus 2 is abnormal, and subsequently, fuzzing is executed using one or more re-executed fuzzes to specify one or more re-executed fuzzes including the cause fuzz based on the monitoring result of the monitoring part 13. According to such a configuration, the operation of manually specifying the cause fuzz performed by the user of the fuzzing apparatus 1 can be reduced in the manner similar to the embodiments 1 and 2; thus, efficiency of executing the fuzzing test can be increased.

The present embodiment 3 can deal with a case where the test target apparatus 2 is not crushed but abnormality occurs in the response from the test target apparatus 2, which cannot be detected in the embodiments 1 and 2; thus, the test can be performed more accurately.

### Another Modification Example

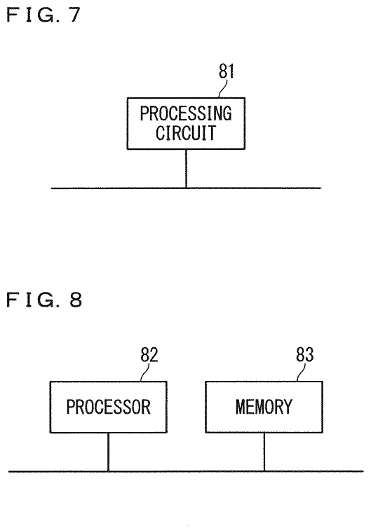

The fuzzer 12, the monitoring part 13, the restart controller 14, and the fuzzing controller 11 in FIG. 1 described above is referred to as “the fuzzer 12 etc.” hereinafter. The fuzzer 12 etc. is achieved by a processing circuit 81 illustrated in FIG. 7. That is to say, the processing circuit 81 includes the fuzzer 12 executing fuzzing of the test target apparatus 2, the monitoring part 13 monitoring whether or not the test target apparatus 2 is crushed, the restart controller 14 restarting the test target apparatus 2, and the fuzzing controller 11 controlling the fuzzer 12 and the restart controller 14 as described above. Dedicated hardware may be applied to the processing circuit 81, or a processer executing a program stored in a memory may also be applied. Examples of the processor include a central processing unit, a processing device, an arithmetic device, a microprocessor, a microcomputer, or a digital signal processor (DSP).

When the processing circuit 81 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 81. Each function of the fuzzer 12 etc. may be achieved by circuits to which the processing circuit is dispersed, or each function of them may also be collectively achieved by one processing circuit.

When the processing circuit 81 is the processor, the functions of the fuzzer 12 etc. are achieved by a combination with software etc. Software, firmware, or software and firmware, for example, fall under the software etc. The software etc. is described as a program and is stored in a memory. As illustrated in FIG. 8, a processor 82 applied to the processing circuit 81 reads out and executes a program stored in the memory 83, thereby achieving the function of each part. That is to say, the fuzzing apparatus 1 includes the memory 83 for storing a program resultingly executing, when executed by the processor 51, steps of: executing fuzzing using a plurality of fuzzes; restarting the test target apparatus 2 when it is monitored that the test target apparatus 2 is crushed; executing the fuzzing using one or more fuzzes less than the plurality of fuzzes in number in the plurality of fuzzes after the test target apparatus 2 is restarted; and specifying the one or more fuzzes including a fuzz crushing the test target apparatus 2 based on a monitoring result that the test target apparatus 2 is crushed on the fuzzing using the one or more fuzzes. In other words, this program is also deemed to make a computer execute a procedure or a method of the fuzzer 12 etc. Herein, the memory 83 may be a non-volatile or volatile semiconductor memory such as a random access memory (RAM), a read only memory (ROM), a flash memory, an erasable programmable read only memory (EPROM), or an electrically erasable programmable read only memory (EEPROM), a hard disk drive (HDD), a magnetic disc, a flexible disc, an optical disc, a compact disc, a mini disc, a digital versatile disc (DVD), or a drive device of them, or any storage medium which is to be used in the future.

Described above is the configuration that each function of the fuzzer 12 etc. is achieved by one of the hardware and the software, for example. However, the configuration is not limited thereto, but also applicable is a configuration of achieving a part of the fuzzer 12 etc. by dedicated hardware and achieving another part of them by software, for example. For example, the function of the fuzzer 12 can be achieved by the processing circuit 81 as the dedicated hardware, for example, and the function of the other parts can be achieved by the processing circuit 81 as the processor 82 reading out and executing the program stored in the memory 83.

As described above, the processing circuit 81 can achieve each function described above by the hardware, the software, or the combination of them, for example. The same applies to the embodiments 2 and 3.

Each embodiment and each modification example can be arbitrarily combined, or each embodiment and each modification example can be appropriately varied or omitted.

The foregoing description is in all aspects illustrative and does not restrict the invention. It is therefore understood that numerous modification examples not illustrated can be devised.

### Explanation of Reference Signs

1 fuzzing apparatus, 2 test target apparatus, 11 fuzzing controller, 12 fuzzer, 13 monitoring part, 14 restart controller.

1. A fuzzing apparatus, comprising:
a fuzzing execution circuitry executing fuzzing of a test target apparatus;
a monitor monitoring whether or not the test target apparatus is crushed;
a restart controller restarting the test target apparatus; and
a fuzzing controller controlling the fuzzing execution circuitry and the restart controller, wherein
the fuzzing controller
makes the fuzzing execution circuitry execute the fuzzing using a plurality of fuzzes,
makes the restart controller restart the test target apparatus when the monitor monitors that the test target apparatus is crushed,
makes the fuzzing execution circuitry execute the fuzzing using one or more fuzzes less than the plurality of fuzzes in number in the plurality of fuzzes after the test target apparatus is restarted, and
specifies the one or more fuzzes including a fuzz crushing the test target apparatus based on a monitoring result of the monitor on the fuzzing using the one or more fuzzes.

2. The fuzzing apparatus according to claim 1, wherein
the one or more fuzzes selectively include a first fuzz to a second fuzz in an order in which the plurality of fuzzes are sequentially used for the fuzzing, the first fuzz used for the fuzzing when the monitor monitors that the test target apparatus is crushed, and the second fuzz used for the fuzzing at a predetermined time before a point of time when the first fuzz is used for the fuzzing.

3. The fuzzing apparatus according to claim 1, wherein
the fuzzing controller sets a time interval of using the one or more fuzzes to be longer than a time interval of using the plurality of fuzzes.

4. The fuzzing apparatus according to claim 1, wherein
the one or more fuzzes selectively include a primary first fuzz to a second fuzz corresponding to half of the plurality of fuzzes and a third fuzz next to the second fuzz to a final fourth fuzz in an order in which the plurality of fuzzes are sequentially used for the fuzzing.

5. A fuzzing method of executing fuzzing of a test target apparatus, comprising:
executing the fuzzing using a plurality of fuzzes;
restarting the test target apparatus when it is monitored that the test target apparatus is crushed;
executing the fuzzing using one or more fuzzes less than the plurality of fuzzes in number in the plurality of fuzzes after the test target apparatus is restarted; and
specifying the one or more fuzzes including a fuzz crushing the test target apparatus based on a monitoring result that the test target apparatus is crushed on the fuzzing using the one or more fuzzes.

6. A fuzzing apparatus, comprising:
a fuzzing execution executing fuzzing of a test target apparatus;
a monitor monitoring whether or not a response from the test target apparatus is normal;
a restart controller restarting the test target apparatus; and
a fuzzing controller controlling the fuzzing execution circuitry and the restart controller, wherein
the fuzzing controller
makes the fuzzing execution circuitry execute the fuzzing using a plurality of fuzzes,
makes the restart controller restart the test target apparatus when the monitor monitors that the response from the test target apparatus is abnormal,
makes the fuzzing execution circuitry execute the fuzzing using one or more fuzzes less than the plurality of fuzzes in number in the plurality of fuzzes after the test target apparatus is restarted, and
specifies the one or more fuzzes including a fuzz causing abnormality of the response from the test target apparatus based on a monitoring result of the monitor on the fuzzing using the one or more fuzzes.

7. The fuzzing apparatus according to claim 6, wherein
the monitoring of the monitor includes at least any one of:
monitoring whether or not a response comes from the test target apparatus to which a packet is sequentially transmitted in a predetermined time;
monitoring whether or not a response indicating a correct content comes from the test target apparatus; and
monitoring whether or not a response indicating a correct state transition comes from the test target apparatus.
